(19) United States
(12) Patent Application Publication
(10) Pub. No.: US 2021/0073800 A1
(43) Pub. Date: Mar. 11, 2021

(54) Coin-Basis application designed to calculate the basis of crypto currency

(71) Applicants: Carl B. Ingram, Tempe, AZ (US); Michael Pickett, New York, NY (US); Tom Brown, New York, NY (US)

(72) Inventors: Carl B. Ingram, Tempe, AZ (US); Michael Pickett, New York, NY (US); Tom Brown, New York, NY (US)

(21) Appl. No.: 17/085,939

(22) Filed: Oct. 30, 2020

Related U.S. Application Data
(62) Division of application No. 16/359,483, filed on Mar. 20, 2019, now abandoned.
(60) Provisional application No. 62/645,286, filed on Mar. 20, 2018.

(51) Int. Cl. G06Q 20/38; H04L 9/32; G06Q 20/06

(52) U.S. Cl. CPC G06Q 20/381; H04L 9/3213; H04L 2209/56; G06Q 2220/00; G06Q 20/0658

(57) ABSTRACT

The coin-basis engine is used to determine crypto currency basis functions as a real time calculator and index for real-time basis determination and value tracking for any crypto currency. The coin-basis engine analyzes blockchain transactions for a heterogenous mix of blockchain based or digital crypto-currencies, market events, currency exchanges and related property/trade transactions to determine taxable basis and taxable gains of crypto currency tokens. The key components of the coin-basis are the Artificial intelligence (AI) based Coin-basis engine, gateway routers and the blockchain database/ledger.

### CROSS REFERENCE TO RELATED APPLICATIONS

This application is a divisional application of U.S. patent Ser. No. 16/359,483 filed on Mar. 20, 2019, which claims the benefit of U.S. provisional application No. 62/645,286 filed on Mar. 20, 2018. Both applications are incorporated by reference herein.

### REFERENCE TO SEQUENCE LISTING, A TABLE, OR COMPUTER PROGRAM LISTING

Not applicable.

### BACKGROUND OF THE INVENTION

### (1) Field of the Invention

This invention is directed toward difficult financial algorithms for tax purposes requiring advanced artificial intelligence and extensive data complication.

### (2) Description of Related Art

### BACKGROUND

Crypto currencies are used in a worldwide payment system. Their main feature is the use of a decentralized digital currency. Conceptionally, peer-to-peer transactions take place between users directly using the crypto currency, without an intermediary. A public log of the transactions is made.

Rapid changes in Bitcoin currency values has made the crypto currency exchanges unstable and created a need in the financial markets to understand the intrinsic value of all digital currencies. Originally, Bitcoin currency was valued on the computational effort to create the tokens. However, changes in GPU and CPU technologies (computer processing power) and encryption technology have drastically changed the ability to manufacture tokens, contributing to instability in Bitcoin currency markets. A process is needed to measure the true cost basis of the crypto currencies. A solution is needed to;
1. Analyze the history of the digital tokens and block chain
2. Analyze market transaction related to all currencies in the Blockchain
3. Analyze currency exchange rates for various market exchange
4. Analyze Cost basis of a current cumulative currency portfolio owned by an individual that may contain different currencies and cost derived from different currency exchange rates
5. Provide predictive and current true value of the portfolio

The resultant cost and valuation derived from currency cost basis can provide the following benefits;
1. Act as a currency index for various currencies
2. Provide a stabilizing force
3. Provide a tool for taxation
4. Aid in determining origin and related fees analyzing items 1-5 in previous paragraph:
   a. Analyze the history of the digital tokens and block chain using artificial intelligence
   b. Analyze market transaction related to all currency in the blockchain
   c. Analyze currency exchange rates for various market exchange
   d. Analyze Cost basis of a current cumulative currency portfolio owned by an individual that may contain different currencies (such as Stellar and Ethereum) and cost derived from different currency exchange rates
   e. Provide predictive and current true value of the portfolio using machine learning and artificial intelligence (AI)

The resultant cost and valuation derived from currency cost basis can provide the benefits in items 1-4 above.

### STATEMENT OF THE INVENTION

The coin-basis engine is used to determine crypto currency cost basis functions as a real time calculator and index for real-time cost basis determination and value tracking for any crypto currency. The coin-basis engine analyzes blockchain transactions for a heterogenous mix of blockchain based or digital crypto-currencies, market events, currency exchanges and related property/trade transactions to determine taxable basis and taxable gains of crypto currency tokens.

The key components of the coin-basis are the Artificial intelligence (AI) based Coin-basis engine, gateway routers and the blockchain database/ledger.
1. The coin-basis engine uses an AI to interpret the basis algorithm and an integrated intelligent workspace UI/UX,
2. Gateway routers which provides access to registered coins information and is used to aggregate coin value, and
3. A blockchain ledger to track coin-basis results and events.

### BRIEF DESCRIPTION OF THE FIGURES

FIG. 1 is a functional diagram of the coin basis engine.

FIG. 2 is a diagram of the cost basis data flow tables.

FIG. 3 depicts a neural network created by distributed gateways.

### DETAILED DESCRIPTION OF THE INVENTION

Basis (or cost basis), as used in United States tax law, is the original cost of property, adjusted for factors such as depreciation. When property is sold, the taxpayer pays/(saves) taxes on a capital gain/(loss) that equals the amount realized on the sale minus the sold property's basis.

Cost basis is important in tax law because tax is due based on the gain in value of an asset. For example, if a person invests in a gold coin for $20, and sells it for $20, there is no tax, since there is no profit. If, however, that person invests in a gold coin for $20 and then sells it for $25, then there is a capital gain on the gold coin of $5, which is taxable.

Typically, capital gains tax is due only when an asset is sold. However, the rules for this are very complicated. If tax is paid because the value has increased, the new value will be the cost basis for any future tax.

Internal Revenue Service (IRS) Publication 551 contains the IRS's definition of basis: “Basis is the amount of your investment in property for tax purposes. Use the basis of property to figure depreciation, amortization, depletion, and casualty losses. Also use it to figure gain or loss on the sale or other disposition of property.”

To determine cost basis for Bitcoin tokens, the original purchase prices must be known. Bitcoin tokens are bought and sold on the market like any other commodity. For tax purposes, the currency type and exchange rate at the time of purchase and sale is critical to know for a correct computation of capital gain. For example, if a token was purchased in Euros, but the owner is American, the value of the currency must be known at the time of purchase relative to US dollars. Since the transaction ledger for a bitcoin token is stored in the token ledger, this data is available by reading the ledger.

The tax calculation for crypto currencies uses the following basis parameters:

1. Date of purchase

2. Purchase amount (read from ledger)

3. Acquisition type (purchase, inheritance, gift)

4. Purchase currency type

5. Exchange rate

To calculate the cost basis:

1. A data engine captures market value of the crypto currency by using
a. A Gateway
b. Historical Currency values
c. Relative Coin transactional events
d. Token identification information

2. The data engine uses the following formulas:

Crypto Currency Basis(Coin-basis)=sale cost(CVS)−purchase cost(CVP)

Where;

Sale-price=non-Crypto price or market value of exchange(stock,property)at time of exchange

CVS=sale-price(at sale date)*currency conversion rate

CVP=sale-price(at purchase date)*currency conversion rate

Crypto Currency Coin-Basis Engine

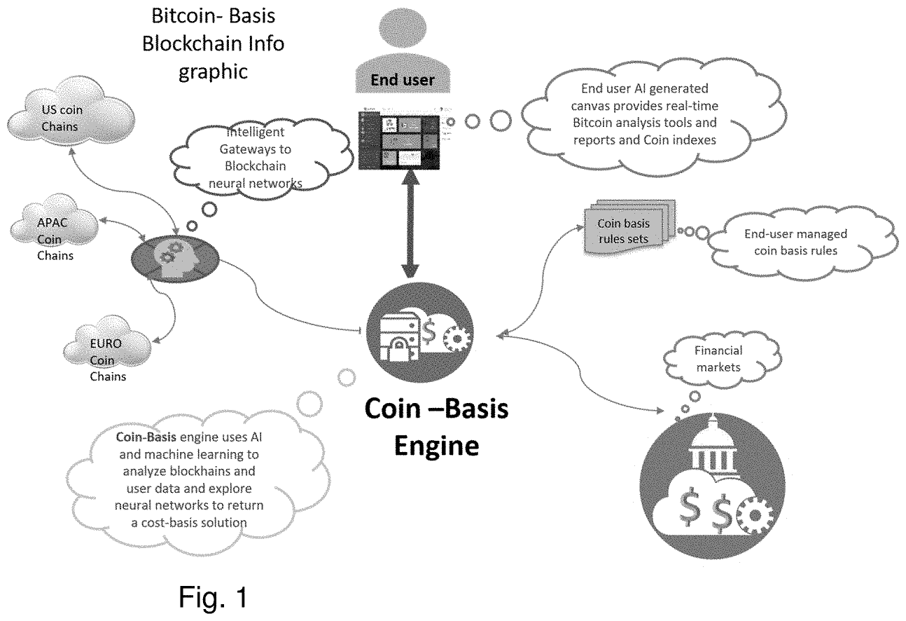

FIG. 1 provides a functional diagram of the coin basis engine. The Coin-basis Engine contains an integrated process of several AI's (Natural speaking AI), Intelligent workspace, Machine learning based raw data engine, Deep learning and Supervised learning modules. The system can connect thru adapters to various data sources, including financial market data feeds, other Coin-basis gateways, and external AI's using rest API thru its integrated gateway.

Artificial Intelligence Engine (AI)

For AI's to be effective, they must be properly trained to enable reliable result. Think of an AI as 7-year-old child, they can perform a task well, when properly trained, but if not, they can have unpredictable results. Two methods are employed to train an AI
1. Supervised learning—An AI is shown by a teacher how to handle a problem
2. Self Learning—an AI is given data and allowed to learn on its own.
   a. DLM (deep learning module)-asymmetric worker process leveraging machine learning and external AI's

Risk Management Module (Supervised Learning Engine)

The Integrated Layer 8 Intelligent Workspace uses a supervised learning module called the Risk Management Module. This module is an end user managed system that accelerates the AI learning to provide real time result within hours. Self-learning is managed by allowing the AI to leverage other AI's to benefit from their learning and allowing the AI to also learn from its assigned users and teams.

AI Engine Architecture

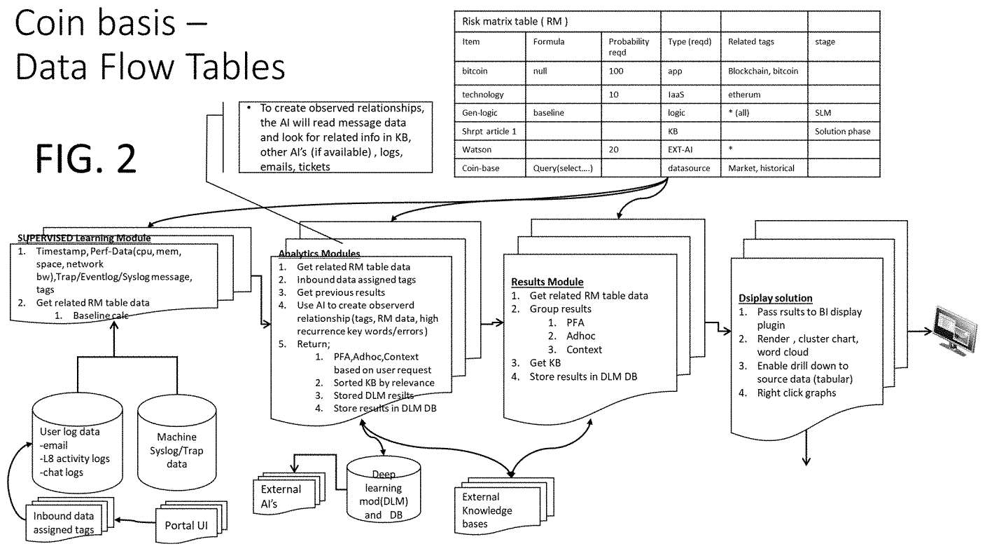

The Coin Basis AI engine use the R language based fuzzy logic queries and Python based software libraries to transform data into desired outputs based on data filtered by databased machine learning revers Bayesian algorithms. The engine modules are depicted in FIG. 2.

Gateway System Architecture

The gateway host utilizes internal ledgers to track transactions. The gateway host uses Python and R libraries to register onto various coin networks. Coin events are captured by the gateway. The AI engine will learn events and for events without learning directives, the AI will push disposition notices to the gateway management staff. Dispositions made by staff will be stored into the AI Self Learning module called the Risk Management Module and its associated Risk Management Table.

Gateway System Architecture—Neural Networks

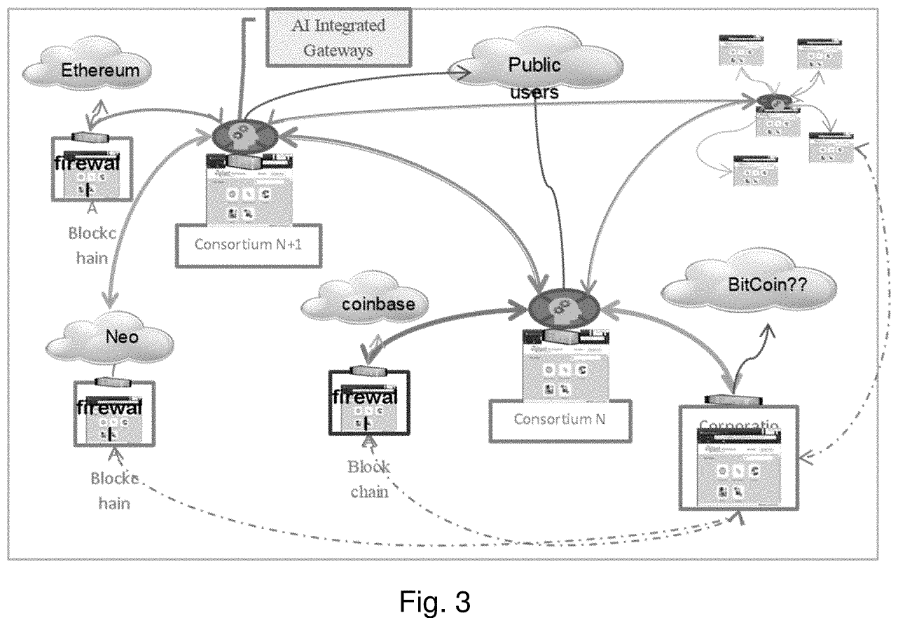

FIG. 3 depicts the resulting Neural network created by distributed gateways. Gateway routers require seven systems to build quorum. As the consortiums grows, the consortium block chain acts as a router and connects Blockchain systems thru discovered neural networks. Entire constellations of networks can be formed, even creating redundant and self-healing, intelligent networks.

Intelligent Workspace Overview

The Layer 8 Intelligent Workspace is a user interface that allows users to securely manage their work. The workspace uses AI Workers or Bots that monitor user actions and data feeds (documents, logs, emails, machine data, etc.) and learns how users manage the data and researches and identifies patterns in the data to suggest actions and potential problems to the user. The Workspace uses a Supervised Learning module (called the Risk Management module) to provide real-time suggestions, information or alerts to individuals and teams on the workspace canvas generated by the AI. Information found by the AI that is deemed critical either by user defined parameters in supervised learning module or learned by the AI is tagged and stored in a blockchain. This automated AI integration can manage proof of work and permissioned block chain and eliminate weakness of blockchains, particularly private blockchains, that allow a compromise of the block chain creation tools to corrupt data in a leger.

Cost Savings—Acquisition and Sustainability

Utilizing the embodied invention, there are significant costs savings for ongoing integration, development, and maintenance costs for a digital valuation service. The service is projected to:
1. Reduce the potential legal cost for mismanaging blockchain contracts and ledgers.
2. Reduce auditing costs.
3. Lower legal costs from potential mismanaging financial information.

While various embodiments of the present invention have been described, the invention may be modified and adapted to various operational methods to those skilled in the art. Therefore, this invention is not limited to the description and figure shown herein, and includes all such embodiments, changes, and modifications that are encompassed by the scope of the claims.

I claim:

1. A method to determine the basis cost of at least one crypto currency token comprising:
A. obtaining a first transaction information of said crypto currency token:
1. a first date of purchase of said crypto currency token;
2. a first purchase amount;
3. a first currency of purchase;
4. a first acquisition type; and
5. optionally, a first exchange rate of said first currency;
B. obtaining a second transaction information of said crypto currency token:
1. a second date of purchase of said crypto currency token;
2. a second purchase amount;
3. a second currency of purchase;
4. a second acquisition type; and
5. optionally, a second exchange rate of said second currency;
C. performing a first calculation to determine a first basis cost utilizing said first transaction information;
D. performing a second calculation to determine a second basis cost utilizing said second transaction information; and
E. determining a final basis cost by performing a subtraction between said first basis cost and said second basis cost;
F. utilizing a coin-basis engine, gateway routers, and crypto currency token ledger in:
1. obtaining said first transaction information;
2. obtaining said second transaction information;
3. performing said first calculation; and
4. performing said second calculation;
and
G. whereby a currency index for said basis cost of at least one crypto currency token is provided.
